(19) United States
(12) Patent Application Publication
(10) Pub. No.: US 2014/0379336 A1
(43) Pub. Date: Dec. 25, 2014

(54) EAR-BASED WEARABLE NETWORKING DEVICE, SYSTEM, AND METHOD

(71) Applicant: Atul BHATNAGAR, Saratoga, CA (US)

(72) Inventor: Atul BHATNAGAR, Saratoga, CA (US)

(21) Appl. No.: 14/310,503

(22) Filed: Jun. 20, 2014

Related U.S. Application Data
(60) Provisional application No. 61/837,483, filed on Jun. 20, 2013.

(51) Int. Cl. G10L 17/22; G10L 15/26; H04R 1/10

(52) U.S. Cl. CPC G10L 17/22; H04R 1/1091; G10L 15/26
USPC 704/235; 704/275

(57) ABSTRACT

An ear-based wearable networking device, system, and method is disclosed. The wearable networking device, system, and method is configured to monitor and process plural conversations in proximity of a user and store the associated information in a cloud system. The cloud system is configured to, based on the associated information, process, archive, create alerts, create reminders, retrieve, etc.

### FIELD OF THE DISCLOSURE

The present disclosure relates generally to wearable computing and networking systems and methods. More particularly, the present disclosure relates to ear-based wearable networking device, system, and method.

### BACKGROUND OF THE DISCLOSURE

Due to the convergence of high-speed wireless connectivity, low power computing, and smaller form-factor devices, wearable computing devices are emerging. For example, smartphones are typically always on and located on or near an associated user. However, a conventional smartphone is typically only always on from the perspective of a telephone call, text message, email, etc. That is, the conventional smartphone is always on from a reception perspective. Emerging wearable devices include Google Glass from Google, Inc. which includes an eyeglass based visual display communicatively coupled to a user's smartphone. The Glass focuses on visual content, but again is not always on unless enabled by a user. Also, the Glass disadvantageously is cumbersome in the field of a user's view as well as distinctly obvious on a user's face. From a user perspective, most communication between people is verbal. It would be advantageous to provide a ubiquitous ear-based wearable device leveraging the aforementioned convergence.

### BRIEF SUMMARY OF THE DISCLOSURE

In various exemplary embodiments, the present disclosure relates to ear-based wearable networking device, system, and method. The wearable networking device, system, and method is configured to monitor and process plural conversations in proximity of a user and store the associated information in a cloud system. The cloud system is configured to, based on the associated information, process, archive, create alerts, create reminders, retrieve, etc.

In an exemplary embodiment, a wearable networking device includes a physical housing configured to fit on or in a user's ear; an audio interface communicatively coupled to a microphone and a speaker; a wireless interface; a processor communicatively coupled to the audio interface and the wireless interface; memory storing instructions that, when executed, cause the processor to: record audio in proximity to the user; analyze and compress the audio; and store the compressed audio in a cloud-based system along with identifying information via the wireless interface.

In another exemplary embodiment, a wearable networking system includes a network interface; a data store; a processor communicatively coupled to the network interface and the data store; memory storing instructions that, when executed, cause the processor to: receive audio data from at least one ear-based device associated with a user; analyze the audio data for actionable items associated therewith; push the actionable items to at least one application associated with a mobile device of the user; and store the audio data in a searchable format for later retrieval.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a wearable networking system;

FIG. 2 is a block diagram of exemplary functional components of an ear-based device;

FIG. 3 is a schematic diagram of an exemplary implementation of a physical housing of the ear-based device of FIG. 2;

FIG. 4 is a block diagram illustrates a server which may be used in the system of FIG. 1, in other systems, or standalone; and

FIG. 5 is a block diagram of a mobile device which may be used in the system of FIG. 1 with the ear-based device or the like.

### DETAILED DESCRIPTION OF THE DISCLOSURE

Again, in various exemplary embodiments, the present disclosure relates to ear-based wearable networking device, system, and method. The wearable networking device, system, and method is configured to monitor and process plural conversations in proximity of a user and store the associated information in a cloud system. The cloud system is configured to, based on the associated information, process, archive, create alerts, create reminders, retrieve, etc. It is said that an individual cannot tell you exactly what she was doing on a specific date in the past, but Google can. It is an objective of the wearable networking device, system, and method to provide an answer to this question, e.g. what delivery date did I promise customer X four months ago? The wearable networking device, system, and method can be an ultimate productivity tool enabling seamless archiving and integration with automation tools (e.g., calendar, to-do lists, contact lists, etc.). Additionally, the wearable networking device, system, and method can provide additional functions such as visually-impaired assistance, notification of interesting proximate conversations, etc.

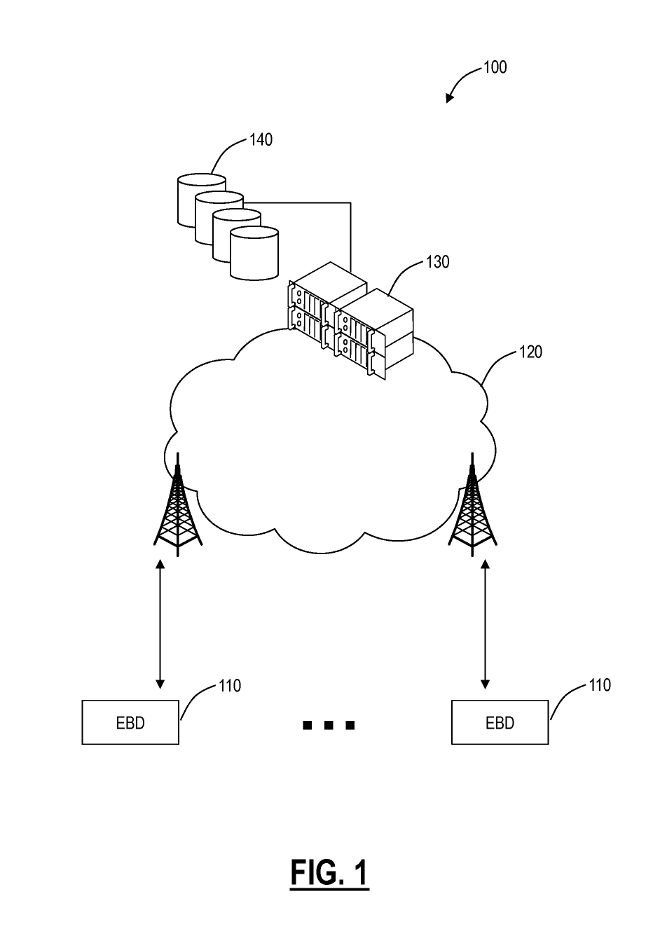

Referring to FIG. 1, in an exemplary embodiment, a network diagram illustrates a wearable networking system 100. The wearable networking system 100 includes one or more ear-based devices 110 that are communicatively coupled to a network 120 to one or more servers 130 which can be communicatively coupled to one or more data stores 140. The ear-based device 110 is a wearable computing device that can attach to or be place in a user's ear. Other wearable locations are also contemplated for the device 110. The ear-based device 110 generally is configured to monitor and record audio conversations in a proximity of an associated user. In an exemplary embodiment, the ear-based device 110 includes a telescopic configuration enabling the device 110 to pick up audio outside of the user's hearing range. In another exemplary embodiment, the ear-based device 110 is configured to monitor a plurality of concurrent conversations and process them individually.

In general, the ear-based device 110 is configured to record and store audio that is proximate to the user. Specifically, the ear-based device 110 includes a wireless connection to the network 120. The network 120 can include a combination of networks such as the Internet, wireless networks, local area networks, etc. In an exemplary embodiment, the ear-based device 110 includes a wireless connection to the network 120. The one or more servers 130 forms a cloud-based system that is configured to process, act on, and archive audio from the one or more ear-based devices 110. In an exemplary embodiment, the one or more ear-based devices 110 provide a first stage of audio processing, and the one or more servers 130 provide a second stage of audio processing.

The first stage of audio processing can include a cursory analysis to determine conversations of interest outside the user's range as well as compression of the audio for wireless transmission. The second stage of audio processing can include determining location, such as based on Global Positioning System (GPS) coordinates of the device 110, converting audio to text, analyzing the text for actionable items such as calendar events, to-do action items, or other information of note, alerting the user of any determined actionable items, archiving the audio or text by data and location in the data stores 140, and the like.

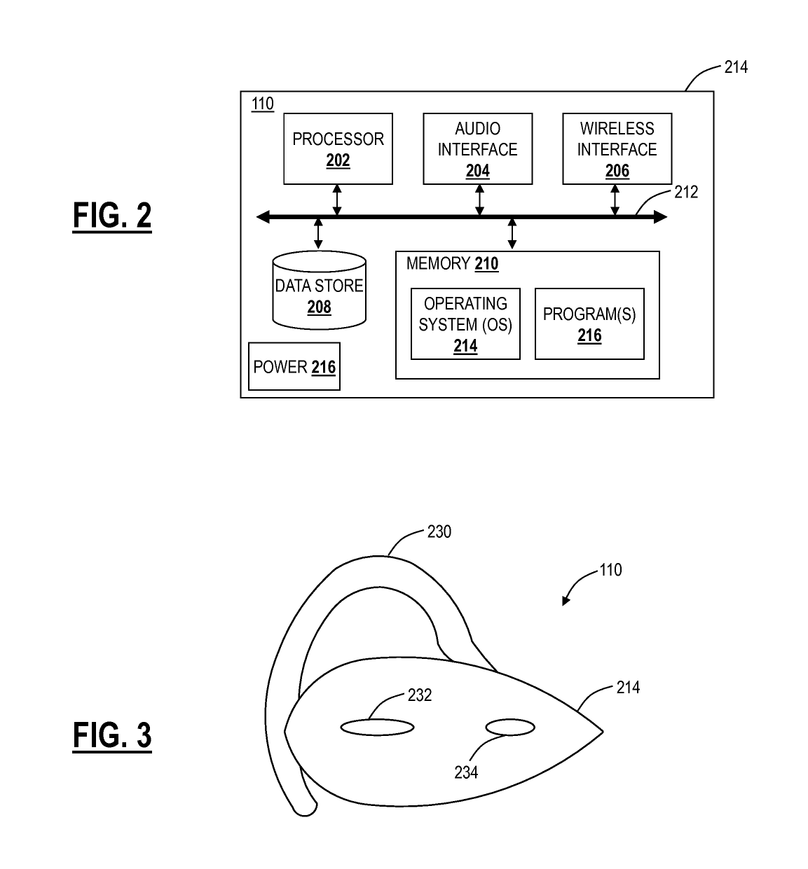

Referring to FIG. 2, in an exemplary embodiment, a block diagram illustrates exemplary functional components of an ear-based device 110. The ear-based device 110 can be a digital device that, in terms of hardware architecture, generally includes a processor 202, an audio interface 204, a wireless interface 206, a data store 208, and memory 210. It should be appreciated by those of ordinary skill in the art that FIG. 2 depicts the ear-based device 110 in an oversimplified manner, and a practical embodiment may include additional components and suitably configured processing logic to support known or conventional operating features that are not described in detail herein. The components (202, 204, 206, 208, and 202) are communicatively coupled via a local interface 212 and housed in a physical housing 214. The local interface 212 can be, for example but not limited to, one or more buses or other wired or wireless connections, as is known in the art. The local interface 212 can have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The physical housing 214 can include a form factor that is configured to attach to or fit in a user's ear. Additionally, the physical housing 214 can include a power module 216 that is coupled to the components (202, 204, 206, 208, and 202). The power module 216 can include a rechargeable battery and an associated charging interface. For example, the charging interface can be plugged in during off-hours at night or as needed. FIG. 3, in an exemplary embodiment, illustrates an exemplary implementation of the physical housing 214 of the ear-based device 110. Those of ordinary skill in the art will recognize FIG. 3 is presented for illustration purposes only and practical embodiments of the ear-based device 110 can include various form factors for the physical housing 214.

The physical housing 214 includes an ear connection piece 230, a visual indicator 232, and a microphone 234. The ear connection piece 230 enables the ear-based device 110 to fit on a user's ear. The visual indicator 232 can be a light emitting diode (LED) or the like that is indicative of operation of the ear-based device 110. The microphone 234 can be an omnidirectional microphone that is communicatively coupled to the audio interface 204. Additionally, the ear-based device 110 can include a speaker on an opposite side of the physical housing 214 from the microphone 234 to provide audio to the user's ear. In an exemplary embodiment, the physical housing 214 can also include a video device facing forward. The video device can also be communicatively coupled to the local interface 212 and the other components in the ear-based device 110. The video device can record and forward video to the cloud in a similar manner as audio. This could allow blind or other visually-impaired people getting directions and advisory with the video device watching for safety and direction.

The processor 202 is a hardware device for executing software instructions. The processor 202 can be any custom made or commercially available processor, a central processing unit (CPU), an auxiliary processor among several processors associated with the ear-based device 110, a semiconductor-based microprocessor (in the form of a microchip or chip set), or generally any device for executing software instructions. When the ear-based device 110 is in operation, the processor 202 is configured to execute software stored within the memory 210, to communicate data to and from the memory 210, and to generally control operations of the ear-based device 110 pursuant to the software instructions. In an exemplary embodiment, the processor 202 may include a mobile optimized processor such as optimized for power consumption and mobile applications.

The audio interface 204 is configured to receive audio from the microphone 234 and transmit audio to the speaker. The audio interface 204 can include analog-to-digital (ADC) and digital-to-analog (DAC) converters to provide digitized audio to the processor 202 as well as to the speaker. Further, the audio interface 204 is configured to process plural conversations simultaneously and separate each. This can be done in conjunction with the processor 202 by monitoring volume, frequencies, etc. to separate disparate conversations happening in proximity to the user. In conjunction with conversations that the user is not a part of, the ear-based device 110 and/or the server 130 can provide an alert to the user of a possible conversation of interest. In an exemplary embodiment, this can include an audio notification. In another exemplary embodiment, this can include a notification via a mobile device.

The audio interface 204 can also be telescoping and omnidirectional. In this manner, it is expected the ear-based device 110 will enable the user to hear conversations and audio at a distance. In an exemplary embodiment, the ear-based device 110 can include audio filtering to enable the user to hear one specific conversation in the midst of several conversations, noise, and the like. In an exemplary embodiment, the ear-based device 110 can provide improved hearing/vision for the user. This can be used in the context of visually-impaired individuals providing notifications of hazards as well as providing enhanced audio via the speaker.

The wireless interface 206 enables the ear-based device 110 to communicate wirelessly to the network 120. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

In an exemplary embodiment, the wireless interface 206 is configured to directly communicate on the network 120 such as via wireless local area network (WLAN), 3G, 4G, LTE, etc. In another exemplary embodiment, the wireless interface 206 is configured to communicate to a corresponding mobile device such as via Bluetooth or the like with the mobile device including an application to communicate to the server 130 for the ear-based device 110. In yet another exemplary embodiment, the wireless interface 206 can also include a GPS device that tracks a real-time location of the user. This real-time location can be used to store and annotate the audio in the cloud as well as track the user's whereabouts. That is, wireless connectivity of the ear-based device 110 can be direct (via the wireless interface 206) or through a smart phone or any Bluetooth like device (via the wireless interface 206).

The data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. The data store 208 is configured to store a portion of audio prior to transmitting the audio to the servers 130. The memory 210 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 can include one or more software programs, each of which includes an ordered listing of executable instructions for implementing logical functions.

In the example of FIG. 2, the software in the memory 210 includes a suitable operating system (O/S) 214 and programs 216. The operating system 214 essentially controls the execution of other computer programs, and provides scheduling, input-output control, file and data management, memory management, and communication control and related services. The programs 216 may include various applications, add-ons, etc. configured to provide end user functionality with the ear-based device 110.

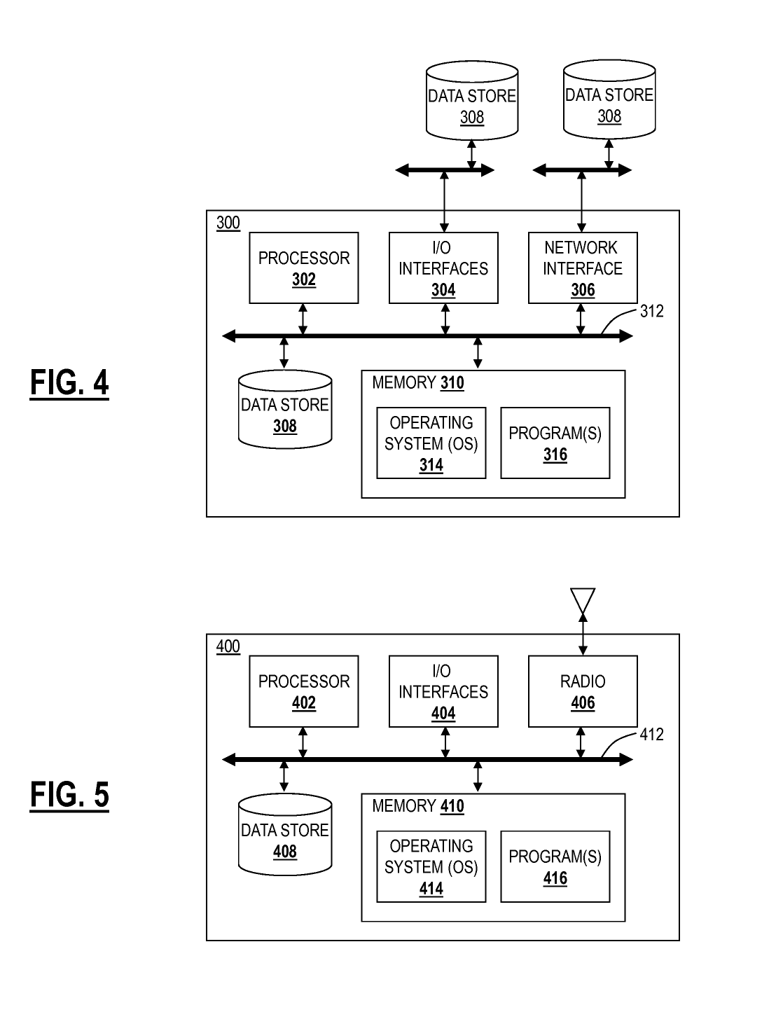

Referring to FIG. 4, in an exemplary embodiment, a block diagram illustrates a server 130 which may be used in the system 100, in other systems, or standalone. The server 130 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 4 depicts the server 130 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 130, a semiconductor-based microprocessor (in the form of a microchip or chip set), or generally any device for executing software instructions. When the server 130 is in operation, the processor 302 is configured to execute software stored within the memory 310, to communicate data to and from the memory 310, and to generally control operations of the server 130 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 130 to communicate on a network, such as the Internet, the WAN 101, the enterprise 200, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 1208 may be located internal to the server 130 such as, for example, an internal hard drive connected to the local interface 312 in the server 130. Additionally in another embodiment, the data store 308 may be located external to the server 130 such as, for example, an external hard drive connected to the I/O interfaces 304 (e.g., SCSI or USB connection). In a further embodiment, the data store 308 may be connected to the server 130 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (0/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

Generally, the wearable networking system 100 may generally refer to a cloud-based system with the servers 130. Cloud computing systems and methods abstract away physical servers, storage, networking, etc. and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser, with no installed client version of an application required. The phrase “software as a service” (SaaS) is sometimes used to describe application programs offered through cloud computing. A common shorthand for a provided cloud computing service (or even an aggregation of all existing cloud services) is “the cloud.”

Referring to FIG. 5, in an exemplary embodiment, a block diagram illustrates a mobile device 400, which may be used in the system 100 with the ear-based device 110 or the like. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 5 depicts the mobile device 410 in an oversimplified manner, and a practical embodiment may include additional components and suitably configured processing logic to support known or conventional operating features that are not described in detail herein. The components (402, 404, 406, 408, and 402) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 410, a semiconductor-based microprocessor (in the form of a microchip or chip set), or generally any device for executing software instructions. When the mobile device 410 is in operation, the processor 402 is configured to execute software stored within the memory 410, to communicate data to and from the memory 410, and to generally control operations of the mobile device 410 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 410. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 5, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with a network such as the system 100.

The wearable networking system 100 assumes verbal communication is the primary means by which individuals communicate to one another. With this assumption, audio is an effective tool to manage a user's interactions in a business, social, and personal perspective. The goal of the wearable networking system 100 is to answer the question—what did I exactly tell client X last week, or what promise did I make to my wife about Y, etc. Using the convergence of small form-factor devices, the exponential increase in computing power, high-bandwidth wireless networking, it is possible to record, process, and archive all audio communication of a user with the ear-based device 110. The server 130 can also be communicatively coupled to the mobile device 400 associated with a user of the ear-based device 110. Here, the server 130 can determine actions, to-do items, calendar events, etc. that are pushed to various applications on the mobile device 400. That is, the server 130 can include a real-time processing engine that identifies actionable items in audio. Additionally, the audio can be pre-processed for relevancy and stored accordingly. In this manner, business-related information can be stored in full while personal information can be stored in part as needed or based on configuration. Also, the user can have a configuration template where keywords are identified for information storage.

In an exemplary embodiment, the server 130 can store audio as both audio and corresponding searchable text. In another exemplary embodiment, the server 130 can convert and store the audio solely as searchable text. The server 130 can include a web-based graphical user interface (GUI) and/or the mobile device 400 can include an application that interfaces with the server 130. Here, a user can perform searches of archived conversations to identify information. There are numerous applications in business, social, personal, education, etc. For example, in the educational context, a student would not have to take detailed notes, but rather could access a transcript of a lecture after the fact using the ear-based device 110. Relevant info comes, via audio, to the ear-based device 110 and a user based on locale, time of the day, people you are talking to, etc., and in this context, the ear-based device 110 and associated cloud-based system makes a user super intelligent with intuition and relevant info at the right time just when it is needed.

The ear-based device 110 can also respond to voice commands of a user for operation. That is, the audio interface 404 in conjunction with the microphone 234 can provide control of the ear-based device 110 via voice command of the user. In another exemplary embodiment, an application on the mobile device 400 can be used to control the ear-based device 110. Control can include, without limitation, turning on/off audio capture, turning on/off the ear-based device 110, uploading/downloading information from the server 130, searching archived audio/text, etc.

In an exemplary application, the ear-based device 110 can be used by a user while driving and the like. Here, the ear-based device 110 advantageously does not obstruct the user's view, a key disadvantage of eye worn devices. In this use, the ear-based device 110 can provide directions, respond to voice queries, provide traffic alerts, and other location relevant information.

The ear-based device 110 can also provide enhanced security and public safety. For example, if a user is traversing an unsafe area, the ear-based device 110 can take video and advice the user, via the speaker in the ear, of appropriate danger. Also, video and/or audio can be automatically sent to public safety officials or the cloud with GPS. In an exemplary embodiment, the ear-based device 110 can connect a user silently to the police with live audio streaming.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A wearable networking device, comprising:
a physical housing configured to fit on or in a user's ear;
an audio interface communicatively coupled to a microphone and a speaker;
a wireless interface;
a processor communicatively coupled to the audio interface and the wireless interface;
memory storing instructions that, when executed, cause the processor to:
record audio in proximity to the user;
analyze and compress the audio; and
transmit the compressed audio to a cloud-based system along with identifying information via the wireless interface.

2. The wearable networking device of claim 1, wherein the memory storing instructions that, when executed, further cause the processor to:
receive voice commands from the user; and
perform an action based on the voice commands.

3. The wearable networking device of claim 2, wherein the action comprises any of turning on/off audio capture, turning on/off the wearable networking device, uploading/downloading information from the cloud-based system, and searching archived audio/text.

4. The wearable networking device of claim 1, wherein the memory storing instructions that, when executed, further cause the processor to:
receive a voice command from the user regarding a query of prior activity;
transmit the query to the cloud-based system; and
provide a response to the user from the cloud-based system.

5. The wearable networking device of claim 1, wherein the cloud-based system is configured to process the compressed audio to perform audio-to-text conversion.

6. The wearable networking device of claim 5, wherein the cloud-based system is configured to process the audio-to-text conversion to identify relevant keywords and perform actions based thereon.

7. The wearable networking device of claim 1, further comprising:
a location determining device.

8. The wearable networking device of claim 7, wherein the memory storing instructions that, when executed, further cause the processor to:
tag the identifying information with a location from the location determining device.

9. The wearable networking device of claim 7, wherein the memory storing instructions that, when executed, further cause the processor to:
detect a hazard based on the location determining device; and
provide audible directions based on the hazard.

10. The wearable networking device of claim 7, wherein the memory storing instructions that, when executed, further cause the processor to:
receive a request for directions; and
provide audible directions based on the request.

11. A wearable networking system, comprising
a network interface;
a data store;
a processor communicatively coupled to the network interface and the data store;
memory storing instructions that, when executed, cause the processor to:
receive audio data from at least one ear-based device associated with a user;
analyze the audio data for actionable items associated therewith;
push the actionable items to at least one application associated with a mobile device of the user; and
store the audio data in a searchable format for later retrieval.

12. The wearable networking system of claim 11, wherein the memory storing instructions that, when executed, further cause the processor to:
receive a query from the user; and
perform an action based on the user.

13. The wearable networking system of claim 11, wherein the action comprises searching archived audio/text stored in the data store and associated with the user.
process the audio data to perform audio-to-text conversion.

14. The wearable networking system of claim 13, wherein the action comprises searching archived audio/text stored in the data store and associated with the user.
identify relevant keywords and perform actions based thereon.

15. The wearable networking system of claim 13, wherein the action comprises searching archived audio/text stored in the data store and associated with the user.
tag the audio-to-text conversion with a location from a location determining device.

16. A method, comprising
providing an ear-based wearable networking device;
receiving audio in proximity to the user by the ear-based wearable networking device;
analyzing and compressing the audio; and
transmitting the compressed audio to a cloud-based system along with identifying information via a wireless interface in the ear-based wearable networking device.
